(19) United States
(12) Patent Application Publication
(10) Pub. No.: US 2009/0286697 A1
(43) Pub. Date: Nov. 19, 2009

(54) LOST CIRCULATION COMPOSITION

(76) Inventor: MANO SHAARPOUR, HOUSTON, TX (US)

Correspondence Address: TIMOTHY F. MILLS, 1177 WEST LOOP SOUTH, SUITE 400, HOUSTON, TX, 77027-9012, US

(21) Appl. No.: 12/408,801

(22) Filed: Mar. 23, 2009

Related U.S. Application Data
(63) Continuation-in-part of application No. 11/115,729, filed on Apr. 26, 2005.

(51) Int. Cl. C09K 8/035; C09K 8/03; C09K 8/02

(52) U.S. Cl. 507/104; 507/140; 507/100

(57) ABSTRACT

A composition of matter and a method of sealing a permeable formation are provided incorporating the composition to reduce or eliminate lost circulation in permeable formations up to at least 5100 psi. The composition comprises one or more sealing components, a wetting component, a viscosifier component, an activator or flocculant component, and an extender. A dry mixture of the components may be added directly from the bag to the drilling mud up to the rate of 90 pounds per barrel. The mixture will seal the formation in an aqueous or organic environment. The mixture de-waters at a rapid rate without regard to the time and temperature required for curing agents or other additives. The mixture may be weighted and does not require additional agents such as defoamers, accelerators, retarders or spacers to de-water and set as a solid plug.

### CROSS-REFERENCE TO RELATED APPLICATIONS

This application is a continuation-in-part of application Ser. No. 11/115,729 filed Apr. 26, 2005.

### BACKGROUND

The present invention relates generally to lost circulation remediation materials and methods added to drilling fluid to aid in reducing or eliminating fluid losses in a subterranean formation. Particularly to a composition of matter for sealing permeable formations encountered in the drilling of a well thus restoring lost circulation. More particularly, the present invention relates to an improved composition and method for reducing lost circulation when fluids of either aqueous or non-aqueous based drilling fluids are employed.

Lost circulation in drilling oil, gas, water or geothermal wells refers generally to the quantities of drilling mud lost to an underground formation, usually a cavernous, pressured or coarsely permeable bed, but it could also be a zone containing microfractures or microfissures, evidenced by a partial or complete failure of the mud to return to the surface as it is being circulated through the drill string to the boring bit and back up the bore hole to the surface. Lost circulation zones are remediated generally by addition of bridging materials or sealing materials. Bridging materials generally comprise larger particulate sizes. Bridging materials are generally employed in cavernous or porous formations. Examples of bridging materials include but are not limited to angular carbon compounds, plant fibers such as nut shells, naturally occurring materials such as diatomaceous earth mined from ocean sediments, and calcium carbonate ground from marble, and perlite, a volcanic mineral composite. Sealing materials, on the other hand, are generally used to seal smaller fractures or fissures because they comprise particulates of generally smaller sizes. Examples of sealing materials include plant fibers such as wood flour and cellulosic newsprint, and synthetic materials such as polymers. Bridging materials and/or sealing materials are generally placed in the loss zone in a mixture with base liquid known as a ‘pill’, or concentrate. Once in place, pressure is applied to force the materials into the formation. As the pressure is applied the lost circulation material (LCM) looses its liquid component, known as ‘dewatering’, even if the liquid component is substantially organic, to form a plug. If the plug is effective, circulation of the drilling mud is restored. Multiple applications of the same or different LCM may be required to restore circulation. The more effective the LCM, the more rapidly drilling can resume and the lower the cost of the drilling operation.

A third type of loss is known as seepage. Seepage is generally minor loss of drilling fluid in the thief zone after addition of LCM or anywhere along the bore hole. Generally drilling can continue when seepage occurs because of the minor loss of drilling fluid. LCMs of relatively small particulate size may be added directly to the regularly circulating drilling fluid to attenuate seepage losses.

The general purpose of drilling mud is to lubricate the expensive bit and drill string and remove the cuttings. Drilling mud is not normally formulated to bridge or seal lost circulation zones, thus additives may be required. Remediation material for lost circulation has been the subject of research and development almost since the inception of the industry. Advances in lost circulation remediation materials continues from a combination of ingenuity and science.

Numerous off-the-shelf, proprietary and patented LCMs are currently available to add to the well for delivery to the loss or thief zone but may prove deficient or inadequate in regard to specific well requirements, cost, time required, and/or effectiveness.

Co-pending U.S. patent application Ser. No. 11/115,729, filed Apr. 26, 2005, incorporated herein by reference, is a lost circulation composition (hereinafter, LCM1) comprising a mixture of bridging components, sealing components, omnibase wetting and bind component, a viscosifier and an activator. While this composition has been very successful in remediating fluid losses, improvements to the composition as disclosed herein (hereinafter called “lost circulation material 2, or LCM2”) have resulted in significant increases in resilience and compressive strength of the lost circulation material thus enabling it to withstand downhole pressures up to at least 5,100 psi.

The well additive material of U.S. Pat. No. 6,927,194 discloses a well kill treatment to prevent the intrusion of formation fluids into the wellbore while the well is open. The well kill additive includes a dry mixture of water soluble crosslinkable polymer, a crosslinking agent, filter aid, and optionally, a reinforcing material of fibers and/or comminuted plant materials. The components of the treatment included wood fiber, peanut shells, diatomaceous earth, glass beads, and wetting and binding agents. However, it does not disclose the use of, or the advantages of, incorporating mineral wool, fibrous glass, a viscosifier or an activator in the additive, nor its use as a loss control material as claimed in the present invention.

U.S. Pat. No. 6,997,261 and U.S Pat. Application Pub. No. 20090018036 to Burts disclose a conformance treatment composition to plug an opening in subterranean hydrocarbon bearing formation. The conformance additive includes water soluble crosslinkable polymer, a crosslinking agent, a filter aid that is preferably diatomaceous earth, and optionally a reinforcing material. The components of the treatment included wood fiber, peanut shells, diatomaceous earth, glass beads, and wetting and binding agents. However, it does not disclose the use of, or the advantages of, incorporating mineral wool or an activator in the additive, nor its use as a loss control material as claimed in the present invention.

U.S. Pat. No. 7,297,663 discloses an additive for weighted aqueous slurries to reduce lost circulation during well drilling operations. The additive comprises a hardenable alkaline composition comprising mixtures of diatomaceous earth, finely ground paper, a hydrophobic liquid, micronized cellulose and lime. The hydrophobic liquid decreases the time required to prepare the weighted aqueous slurries, i.e., pills, containing the additive. However, the additive does not disclose the use of, or the advantages of, incorporating a viscosifier or a lubricant such as graphite as claimed in the present invention.

The operator is always aware of the importance that the drilling system be as inexpensive as possible to minimize the cost of drilling the well. Alternative LCMs are continually being sought to reduce formulation requirements, well operator employee and equipment time, and increase effectiveness over the broadest range of thief zone formations.

### SUMMARY OF THE INVENTION

The present invention addresses these needs by providing an environmentally useful, rapid dewatering composition that leaves behind a solid dense plug, and methods of use, that is heat resistant, that does not require the curing time of a polymer additive, that mixes directly in any environment, i.e., water, seawater, hydrocarbon or synthetics, in water cuts of 0 to 100% at the rate of up to 90 pounds per barrel. The present invention may be mixed externally in a slugging pit or introduced directly into the drilling mud. It does not require separate well additives such as defoamers, accelerators, retarders, suspenders or spacers thus increasing utility and decreasing overall cost of application.

A composition according to the present invention to reduce drilling fluid losses and/or seal permeable formations to restore lost circulation comprises bridging components and/or sealing components generally having a broad particle size distribution (PSD), wetting agent(s), viscosifier(s) and activator(s). Broadly, the PSD of LCM2 comprises a range of approximately 10 to approximately 750 microns.

The composition of the present invention, LCM2, comprises by weight approximately 30% to approximately 95% of bridging and/or sealing components, from approximately 5% to approximately 25% of omnibase wetting component(s), from approximately 0.5% to approximately 4% viscosifier(s) component(s), approximately 1% to approximately 8% of activator(s) component(s), and approximately 1% to approximately 20% of extender component(s).

In order to provide the broad range of particulate sizes in one preferred embodiment more than one bridging component and/or more than one sealant component may be incorporated into the composition. An example of bridging components would be diatomaceous earth, nut shell fibers and perlite. Exemplary sealing components may be fine wood flour and cellulosic newspaper fiber. The end use of the product influences the number and types of bridging and sealing components incorporated. For example, nut shells are generally commercially available in at least fine, medium and coarse gradings. At large particulate size distributions, nut fibers are generally employed as bridging agents. Perlite is a glass ore composed of aluminum, calcium and/or other alkaline earth silicates. Prior to use in the LCM2 as a bridging or sealing component, the perlite ore is expanded by high temperature methods known in the art to obtain densities of 2 to 10 pounds per cubic foot, preferably 3 to 7 pounds per cubic foot, with the result being a fibrous glass product. One form of commercially available fibrous glass perlite is as pressed into a slab that may then be ground to any desired particle size for the application. Wood flour, also a commercial byproduct, is available in superfine gradings of at least approximately 10-15 microns. At this PSD, wood flour is employed generally as a sealing agent for microfissures and microfractures. Cellulosic newsprint is commercially available in a range of gradings. Depending upon the particulate size it could be employed as a bridging or sealing agent. In use, the smaller particulates aggregate with the larger bridging agents to form a more effective plug.

Preferred wetting components comprise hydrophilic and organophilic properties to facilitate mixing in the broadest range of fluids comprising aqueous and non-aqueous environments. Wetting agents comprise generally natural products or synthetics. The presence of the wetting agent in combination with the other ingredients promotes the direct introduction of the composition into aqueous or organic base fluids, such as fresh water, seawater, saturated salt water, diesel, or synthetic organic base fluids, or a mixture of the two, from 0% to 100% water content, without premixing in a slugging pit if desired. Preferred wetting agents that exhibit said characteristics are collectively labeled herein as omnibase wetting agents, i.e., not limited to aqueous base fluids or synthetic base fluids. An example of available synthetic omnibase wetting agents are surfactants or other types of detergents. An example of a preferred natural product that acts as an omnibase wetting agent is gilsonite, a natural asphaltum that has hydrophilic and organophilic properties. Gilsonite acts as a wetting agent for the solids when introduced into a liquid environment. An additional advantage of gilsonite is that it acts as a defoamer to reduce or eliminate foaming that can be a significant impediment in LCM operations. Another advantage of gilsonite is that it acts as a spacer. A spacer is generally employed as a separate additive to encapsulate the LCM components to make them more effective at the loss zone. Another advantage of gilsonite is that it acts as a binding agent to facilitate formation and stability of the plug.

Viscosifier components of one preferred embodiment comprise generally natural compounds such as xanthan gum and various synthetics known in the art, such as carboxymethylcellulose (CMC). Xanthan gum, a natural non-ionic polymer, can act as a viscosifier and a suspending agent. An additional advantage of xanthan gum is its effectiveness as a sealant.

The activator component, or flocculant, retards hydration so the composition will dewater more rapidly. One type of preferred activator is represented by the inorganic hydroxide, lime.

Extender components of one preferred embodiment comprise generally natural compounds, and preferably mineral wool. Mineral wool may be composed of rock wool, basalt wool or other mineral sources such as slag from metal ore refining. Its strength comes primarily from alumina and silica. The mineral wool fibers are made by known methods of heating the ore or slag to melting and then blowing or spinning the molten material to form fibers. One of the advantageous downhole properties of mineral wool is that it may be employed as an ‘extender’. An ‘extender’, as used herein, means the property to increase the particulate carrying capacity of the fluid to which it is added. In a preferred embodiment, by using an extender the carrying capacity, or suspension, of the LCM2 is greatly increased per unit volume such that up to 90 pounds per barrel may be added to the drilling fluid without significant adverse effect to fluid properties, thereby delivering a more concentrated LCM2 to the loss zone.

The composition of the present invention may be introduced into the drilling mud right from the bag as a dry mix. The composition may be used up to approximately 10 pounds per barrel (ppb) in the circulation system to maintain seepage control, and up to approximately 90 ppb directly into any fluids for loss control before there is significant effect on fluid rheological properties. Even with the addition of 90 ppb of this product into the drilling fluids, the fluids will still have a viscosity useable for drilling because there is no significant adverse effect on fluid rheological properties. In comparison, other loss control products on the market contain types of particulates or fibers that swell and produce an unusable thick viscous mud at greater than 50 pounds per barrel.

The LCM2 composition of the present invention rapidly cures losses without time or temperature dependency. The composition dewaters in the loss zone at a rapid rate to form a solid plug with no requirement of setting time, and without the need for a separate spacer, defoamer, accelerator, suspender, activator or retarder—a complete LCM in one bag. The composition is temperature stable to at least 450 degrees Fahrenheit and complies with the environmental LC50 standard. The composition forms a stable high pressure resistant plug up to at least 5100 psi, whereas compositions comprising cross-linked polymers begin to fail at 100 psi. The LCM2 composition may also be combined with a density agent, such as barite, without loss of performance, or graphite, as a lubricant.

It is an object of the present invention to provide a high pressure lost circulation remediation composition that dewaters at a rapid rate.

It is a further object of the present invention to provide a rapid dewatering, high pressure lost circulation remediation composition comprising a broad particulate distribution of bridging and/or sealing components.

It is a further object of the present invention to provide a rapid dewatering, high pressure lost circulation remediation composition that will both bridge and seal in a loss zone.

It is a further object of the present invention to provide an omnibase, rapid dewatering, high pressure lost circulation remediation composition for addition directly to any drilling fluids right from the bag, with no need for additional mixing equipment.

It is a further object of the present invention to provide an omnibase, rapid dewatering, high pressure, lost circulation remediation composition for aqueous and/or organic environments without the need for additional additives such as a separate spacer, defoamer, accelerator, suspender, activator or retarder—a complete high pressure LCM in one bag.

It is a further object of the present invention to provide a rapid dewatering, lost circulation remediation composition that forms a plug stable at high temperatures and high pressures up to at least 5100 psi.

It is a further object of the present invention to provide a lost circulation remediation composition that is also effective as a sealing additive.

It is a further object of the present invention to provide a rapid dewatering, high pressure, lost circulation remediation composition that is not inhibited by contaminants, that no spacer is required when pumping the slurry, that it will not set inside the drill string, that the composition is not affected by temperature or pH, and that the composition is not time dependent for setting, nor does it require a separate activator or retarder.

### BRIEF DESCRIPTION OF THE DRAWINGS

FIG. 1 is tabulated data of de-watering times and strength characteristics of LCM2.

FIG. 2 is a graph of tabulated data of de-watering times and strength characteristics of LCM2, where the Y axis denotes pounds per square inch (psi).

FIG. 3 is a graph of tabulated data of strength characteristics of LCM2 of various particulate sizes, where the Y axis denotes pounds per square inch (psi).

### DESCRIPTION OF THE PREFERRED EMBODIMENT

The invention comprises an improved loss circulation remediation composition, LCM2, a method of preparing the composition, and a method of remediating fluid loss downhole in a wellbore at a loss zone.

In a preferred embodiment of the invention, the loss circulation remediation composition, LCM2, comprises by weight approximately 30% to approximately 95% of bridging and/or sealing component(s), from approximately 5% to approximately 25% of omnibase wetting component(s), from approximately 0.5% to approximately 4% viscosifier(s) component(s), approximately 1% to approximately 8% of activator(s) component(s), and approximately 1% to approximately 20% of an extender component(s).

In one preferred embodiment of the invention, the loss circulation remediation composition, LCM2, comprises between approximately 33% and approximately 43% by weight of diatomaceous earth as a sealing or bridging component, between approximately 6% and approximately 25% by weight of cellulosic newsprint fibers as a sealing component, between approximately 5% and approximately 15% by weight of nut shells as a bridging component, between approximately 6% and approximately 16% by weight of wood flour as a sealing component, between approximately 5% and approximately 15% by weight of gilsonite as an omnibase wetting component, between approximately 1% and approximately 4% by weight of perlite as a bridging component, between approximately 1% and approximately 3% by weight of xanthan gum as a viscosifier, between approximately 1% and approximately 4% by weight of lime as an activator, and between approximately 1% and approximately 20% by weight of mineral wool as an extender.

A preferred method of preparing the LCM2 comprises mixing together diatomaceous earth, cellulosic newsprint, nut shells, wood flour, gilsonite, perlite, xanthan gum, mineral wool and lime, wherein the composition comprises between approximately 33% and approximately 43% by weight of diatomaceous earth, between approximately 6% and approximately 25% by weight of cellulosic newsprint, between approximately 5% and approximately 15% by weight of nut shells, between approximately 6% and approximately 16% by weight of wood flour, between approximately 5% and approximately 15% by weight of gilsonite, between approximately 1% and approximately 4% by weight of perlite, between approximately 1% and approximately 3% by weight of xanthan gum, between approximately 1% and approximately 4% by weight of lime, and between approximately 1% and approximately 20% by weight of mineral wool, wherein the weight totals 100%.

In another preferred embodiment of the invention, the loss circulation remediation composition, LCM2, comprises between approximately 37% and approximately 39% by weight of diatomaceous earth as a sealing or bridging component, between approximately 7% and approximately 9% by weight of cellulosic newsprint fibers as a sealing component, between approximately 9% and approximately 11% by weight of nut shells as a bridging component, between approximately 10% and approximately 12% by weight of wood flour as a sealing component, between approximately 9% and approximately 11% by weight of gilsonite as an omnibase wetting component, between approximately 2% and approximately 3% by weight of perlite as a bridging component, between approximately 1% and approximately 3% by weight of xanthan gum as a viscosifier, between approximately 2% and approximately 3% by weight of lime as an activator, and between approximately 14% and approximately 16% by weight of mineral wool as an extender.

In another preferred embodiment a lubricant, such as graphite, is incorporated into the LCM2 to aid drilling performance, in a range of between approximately 0.5% and approximately 5% by weight.

In another preferred embodiment a density or weight component, such as barite, is incorporated into the LCM2 to aid location of the LCM2 at the level of the thief zone, in a range preferably between approximately 50 and approximately 450 pounds per barrel. Addition of the weighting component is preferably added to an LCM2 slurry prior to introduction downhole.

The method of fluid loss remediation of the invention comprises generally the LCM2 addition to the drilling fluid to create an LCM2 slurry, locating the LCM2 at the loss zone downhole in the wellbore, rapid dewatering of the LCM2, and plug or cake formation with the resultant drilling fluid loss reduction or elimination at the loss zone. More particularly, the method of fluid loss remediation of the invention comprises the introduction of the LCM2 according to the invention directly into the drilling fluids in the conventional manner in dry form, or as a pill from a slugging pit. It may be added at the rate of up to 90 pounds per barrel without loss of fluid characteristics. The LCM2 then descends downhole in the wellbore to the area of the loss zone as determined by the operator, where the operator applies the necessary pressure to rapidly dewater the LCM2 and cause it to infiltrate the porous formation or loss zone to form a plug, or cake, to significantly reduce or stop drilling fluid losses to the loss zone formation. The following examples are illustrative of the compositions discussed above.

### Example 1

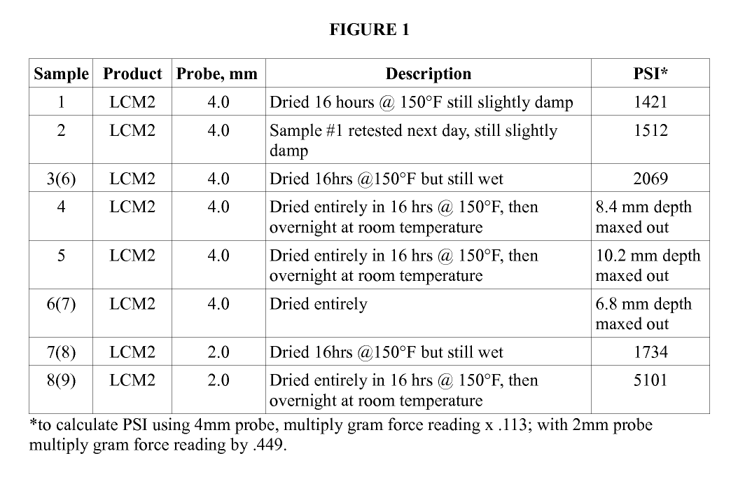

FIG. 1 shows de-watering times and strength characteristics of LCM2. Testing of the compressive strength of the LCM2 was performed by known methods. The purpose of the laboratory testing is to determine the strength and performance of the LCM2 bridge plug by known methods that simulate downhole conditions.

LCM2 was formulated according to the embodiment stated above comprising of between approximately 37% and approximately 39% by weight of diatomaceous earth as a sealing or bridging component, between approximately 7% and approximately 9% by weight of cellulosic newsprint fibers as a sealing component, between approximately 9% and approximately 11% by weight of walnut shells as a bridging component, between approximately 10% and approximately 12% by weight of wood flour as a sealing component, between approximately 9% and approximately 11% by weight of gilsonite as a wetting component, between approximately 2% and approximately 3% by weight of perlite as a bridging component, between approximately 1% and approximately 3% by weight of xanthan gum as a viscosifier, between approximately 2% and approximately 3% by weight of lime as an activator, and between approximately 14% and approximately 16% by weight of mineral wool as an extender.

LCM2 plugs were created and measured for acceptable de-watering times prior to a test for compressive strength. Samples 1 and 2 were prepared by known methods comprising sifting 90 grams of LCM2 into 350 ml of water and then preparing a slurry using a mud mixer. The proportion of 90 grams per 350 ml of liquid is comparable to field conditions where up to at least 90 pounds of LCM2 may be added per barrel of drilling fluid.

It is noted that competitive loss control compositions in diesel or in water can be mixed at maximum rate of approximately 50 pounds per barrel in the field, or in the lab at 50 grams per 350 ml. An advantage of the LCM2 is that it can be mixed at the rate of 90 pounds per barrel in the field, or 90 grams per 350 ml in the laboratory, without altering the fluid properties. Whereas competitive products mixed at even 50 pounds per barrel will become significantly thickened or viscous. This increase in viscosity or thickened fluid will inhibit pumping the product downhole to deliver a substantial amount of product to the loss zone at one time to affect a plug. It is preferable and most desirable in the trade to deliver the maximum amount of LCM to the loss zone in the least amount of time, and have it de-water in the shortest period of time, to quickly decrease or terminate fluid loss in the zone. In addition, the composition of the present invention also provides the advantages of: (1) rapidly reducing the amount drilling fluid lost, and (2) returning the well to drilling as quickly as possible—both of which significantly reduce cost of operation.

When the LCM2 is pumped downhole it substantially de-waters in 60 seconds and adds almost twice as much loss control material to the loss zone at 90 pounds per barrel during de-watering, versus 50 pounds per barrel of competitive products. Thus, by being able to deliver a significantly increased amount of particulates per volume to the loss zone, and in combination with the rapid de-watering characteristics of the LCM2, the LCM2 of the present invention produces plugs rapidly in the loss zone with compressive strength in excess of 5100 psi. The result is a thicker, stronger bridge or plug to reduce or terminate fluid losses as quickly as possible, thereby minimizing additional fluid loss and associated operational costs.

In FIG. 1, the first mixed slurry was sifted into a quart container over a five minute period and then mixed again for an additional two minutes. The resulting second slurry was poured into an API Filter Press®, allowing for approximately three quarters of an inch head space from the top of the cell, and de-watered at 100 psi through OFI™ filter paper. A de-watering time of sixty five seconds was recorded. A de-watering time of 60 seconds is considered an optimal standard that was chosen by the inventor, but is not limiting to the strength of the LCM2. De-watering times in the trade vary widely according to a number of factors including but limited to composition of the LCM, pressure applied, and heat. The de-watering in the laboratory tests by the inventor produces a substantially circular disc or plug (takes the shape of the interior of the press cell) that simulates the behavior of the LCM2 downhole at the loss zone. When used to stop or inhibit drilling fluid loss in a well, LCM2 is mixed with the drilling fluid as described herein and pumped downhole to the loss zone. Pressure is then applied to the well volume which causes the liquid portion carrying the LCM2 to migrate to an area of lower pressure (the cracks and spaces in the underground loss zone formation) leaving the particulate matter of the LCM2 composition to concentrate into what is known in the trade as a cake or plug in the subterranean cracks, spaces and fissures, thereby substantially sealing the well bore.

In a second sample preparation and de-watering test, slurries for Samples 3-9 were obtained by the method stated above. The resulting slurry was poured into an API Filter Press® allowing for approximately three quarters of an inch head space from the top of the cell and de-watered at 100 psi through Whatman No. 50™ filter paper. A de-watering time of fifty seconds was recorded. The rapid de-watering time for both tests was considered acceptable.

In FIG. 1, integrity and compressive strength of each plug was measured by known methods on a QTS Brookfield™ testing instrument utilizing a 2 mm and 4 mm probe. To calculate compressive strength by pounds per square inch (psi) using a 4 mm probe, the instrument gram force reading was multiplied by 0.113, and with a 2 mm probe the instrument gram force reading was multiplied by 0.449. The LCM2 plugs were tested to determine the optimum strength parameters and the effect of drying or curing time on strength. While still damp, Samples 1-3 and 7 tested between 1,734 and 2,069 psi. Completely dry Samples 4-6 maxed out the machine using the 4 mm probe. So, a 2.0 mm probe was utilized for Sample 8 which recorded a reading of 5,101 psi on the instrument. Thus, FIG. 1 shows that the LCM2 has rapid de-watering characteristics, combined with strength which increases as the plug looses the liquid phase, thereby resulting in compressive strength in excess of 5100 psi.

### Example 2

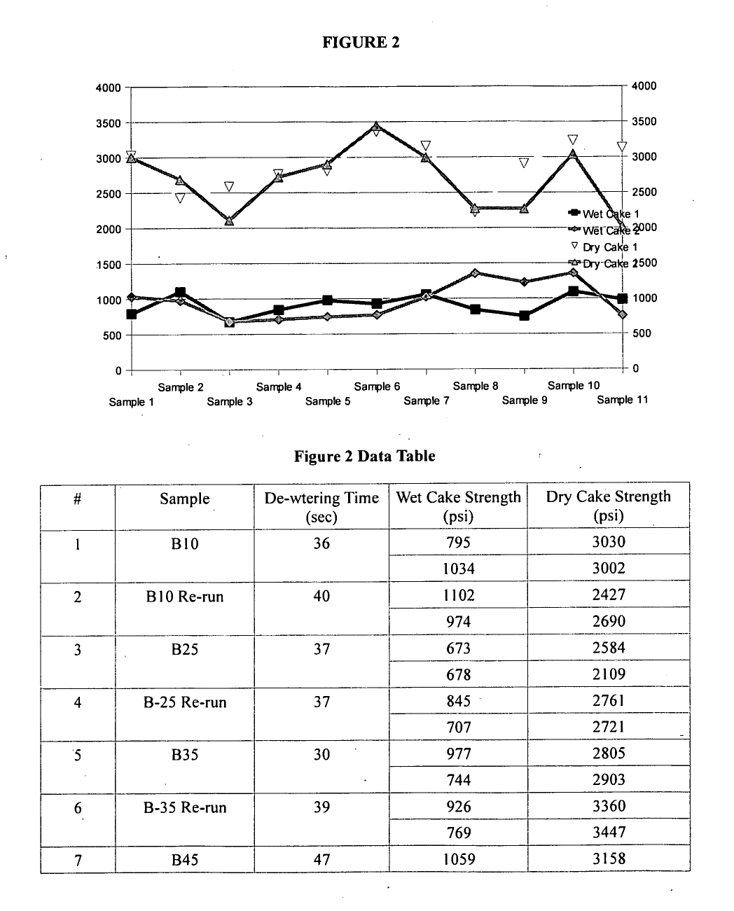

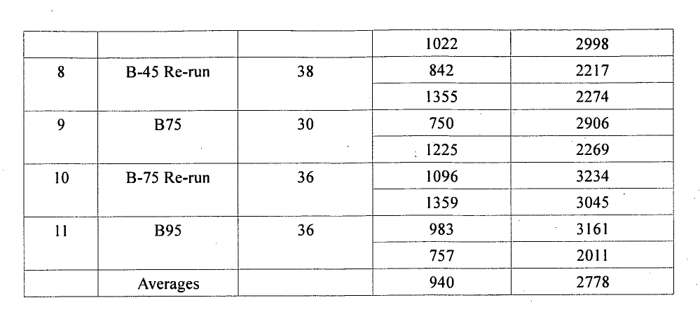

FIG. 2 is a graph and table showing additional de-watering times and strength characteristics of the LCM2 bridge plug by the methods stated above that simulate downhole conditions. The LCM2 was formulated as above in FIG. 1. All sample plugs de-watered in an optimum time of less than 60 seconds. Thus FIG. 2 shows that the LCM2 has repeatable rapid de-watering characteristics combined with strength that increases as the plug looses the liquid phase, and results in an average wet compressive strength of 940 and an average dry compressive strength of 2778 psi for these samples. This retesting and verification of the sample data comparing wet samples to dry samples shows that even though the LCM2 plug is wet in the wellbore it will have a very strong psi to immediately reduce fluid loss while the operator waits for it to completely de-water and dry to gain maximum strength.

### Example 3

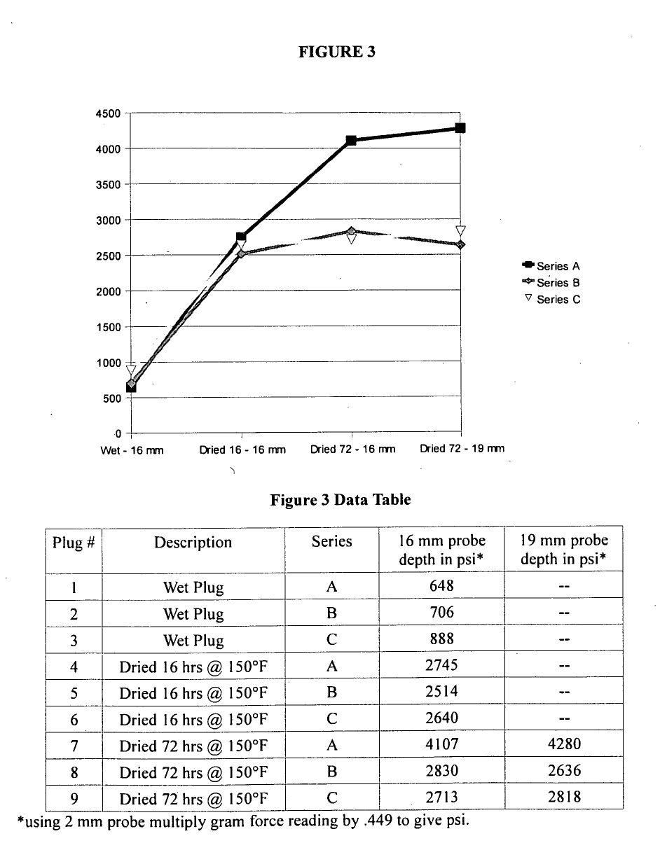

Testing for the effects of drying time and particulate size were performed on the LCM2 composition as shown in FIG. 3. LCM2 plugs 1-9 were made by the methods described above in FIG. 1 using API standard filter paper. The average thickness of the plugs was 20 mm.

Three types of the LCM2 composition were compared:
Series A: Laboratory preparation of composition (60-100 microns)
Series B: Production test material (60-100 microns)
Series C: Production test material—coarser grind (350-750 microns)

Once the plugs were prepared from the samples, three sets of data were obtained from each plug: (1) the psi of the plug immediately following de-watering, i.e., the “wet plug”; (2) the psi of the plug after oven drying at 150 degrees F. for 16 hours; and (3) the psi of the plug after oven drying at 150 degrees F. for approximately 72 hours. All dried plugs, both laboratory and production material, had dried compressive strengths of greater than 2500 psi as verified by the two different probe measurements.

FIG. 3 also illustrates how particulate size affects pressure characteristics of the LCM2. Resiliency is an important factor downhole in that the coarser material demonstrates an increased resiliency, or resistance to pressure prior to failure. Resiliency directly relates to compressive strength of the LCM2 plug. A downhole bridge must exhibit resistance to pressure. Pressure will go to the path of least resistance. The greater the resilience the stronger the plug and the more resistant the plug is to fluid pressure. A plug that is more resilient is more likely to withstand higher pressures downhole. A less resilient plug would tend to be more brittle and thus have a reduced maximum pressure characteristic. In the data of FIG. 3 the coarser material is more resilient because of the cut or size of the bridging particulates (350-750 microns), and the finer the material the less the resiliency.

The composition and methods according to the present invention have multiple applications, several of which comprise open hole remedial and preventative lost circulation squeeze, cased hole squeeze for sealing perforations or casing leaks, as a plug to run in front of cement squeezes, as a plug to improve casing shoe integrity, as a lost circulation preventative material in the drilling mud for possible seepage losses, to name a few.

The composition and methods according to the present invention have multiple advantages, several of which comprise that the composition may be delivered to the site as a single remediation system in one bag, that it can be pumped using the pumps already on the rig to pump the drilling mud, that it can be pumped directly from the mud tank through the downhole tools, or be pre-mixed in aqueous or non-aqueous or a mixture thereof before it is introduced into the bore, that the fluid environment in the well is not a limitation as the composition mixes in aqueous and non-aqueous fluids, and mixtures thereof, that it is not inhibited by contaminants, that no spacer is required when pumping the slurry, that it will not set inside the drill string, that the composition is not affected by temperature or pH, and that the composition is not time dependent for setting, nor does it require a separate activator or retarder.

Although several of the embodiments of the present invention have been described above, it will be readily apparent to those skilled in the art that many other modifications are possible without materially departing from the teachings of this invention. Accordingly, all such modifications are intended to fall within the scope of this invention, as defined in the following claims.

We claim:

1. A lost circulation remediation composition comprising a dry mixture of:
a. between approximately 30% and approximately 95% by weight of at least one bridging component, at least one sealing component, or at least one bridging and one sealing component,
b. between approximately 5% and approximately 25% by weight of an omnibase wetting component,
c. between approximately 0.5% and approximately 4% by weight of viscosifier component,
d. between approximately 1% and approximately 8% by weight of activator component, and
e. between approximately 1% and approximately 20% by weight of an extender component, wherein the weight totals 100%.

2. The composition of claim 1 wherein said sealing component and said bridging component comprise a range of particulate size distribution from 10 to 750 microns.

3. The composition of claim 1 wherein said wetting component is gilsonite.

4. The composition of claim 1 wherein said sealing component is selected from the group consisting of plant fibers and synthetic materials.

5. The composition of claim 1 wherein said sealing component is cellulosic newspaper fiber.

6. The composition of claim 1 wherein said bridging component is selected from the group consisting of angular carbon compounds, plant fibers, nut shells, diatomaceous earth, perlite and calcium carbonate.

7. The composition of claim 1 wherein said viscosifier component is selected from the group consisting of carboxymethylcellulose and xanthan gum.

8. The composition of claim 1 wherein said activator component is an inorganic hydroxide.

9. The composition of claim 1 wherein said activator component is lime.

10. The composition of claim 1 wherein said extender component is mineral wool.

11. The composition of claim 1 comprising:
a. between approximately 33% and approximately 43% by weight of diatomaceous earth,
b. between approximately 6% and approximately 25% by weight of cellulosic newsprint,
c. between approximately 5% and approximately 15% by weight of nut shells,
d. between approximately 6% and approximately 16% by weight of wood flour,
e. between approximately 5% and approximately 15% by weight of gilsonite,
f. between approximately 1% and approximately 4% by weight of perlite,
g. between approximately 1% and approximately 3% by weight of xanthan gum,
h. between approximately 1% and approximately 4% by weight of lime, and
i. between approximately 1% and approximately 20% by weight of mineral wool, wherein the weight totals 100%.

12. The composition of claim 1 comprising:
a. between approximately 37% and approximately 39% by weight of diatomaceous earth,
b. between approximately 7% and approximately 9% by weight of cellulosic newsprint,
c. between approximately 9% and approximately 11% by weight of nut shells,
d. between approximately 10% and approximately 12% by weight of wood flour,
e. between approximately 9% and approximately 11% by weight of gilsonite,
f. between approximately 2% and approximately 3% by weight of perlite,
g. between approximately 1% and approximately 3% by weight of xanthan gum,
h. between approximately 2% and approximately 3% by weight of lime, and
i. between approximately 14% and approximately 16% by weight of mineral wool, wherein the weight totals 100%.

13. A weighted lost circulation remediation composition comprising:
a. between approximately 30% and approximately 95% by weight of at least one bridging component, at least one sealing component, or at least one bridging and one sealing component,
b. between approximately 5% and approximately 25% by weight of an omnibase wetting component,
c. between approximately 0.5% and approximately 4% by weight of viscosifier component,
d. between approximately 1% and approximately 8% by weight of activator component,
e. between approximately 1% and approximately 20% by weight of an extender component, and
f. between approximately 50 and approximately 450 pounds per barrel of a weight or density component.

14. The composition of claim 13 wherein said weight component is barite.

15. A method of decreasing the loss of fluid in a subterranean loss zone comprising introducing the composition of claim 1 into the drilling fluid to create a slurry, locating the composition slurry in the loss zone, applying pressure to the composition slurry in the wellbore, rapidly dewatering the slurry, and producing a cake or plug resistant to drilling fluid loss.

16. A method of decreasing the loss of fluid in a subterranean loss zone comprising introducing the composition of claim 13 into the drilling fluid to create a slurry, locating the composition slurry at the loss zone, applying pressure to the composition slurry in the wellbore, rapidly dewatering the slurry, producing a cake or plug resistant to drilling fluid loss.

17. A method of preparing a lost circulation remediation composition comprising mixing together diatomaceous earth, cellulosic newsprint, nut shells, wood flour, gilsonite, perlite, xanthan gum, mineral wool and lime, wherein the composition comprises between approximately 33% and approximately 43% by weight of diatomaceous earth, between approximately 6% and approximately 25% by weight of cellulosic newsprint, between approximately 5% and approximately 15% by weight of nut shells, between approximately 6% and approximately 16% by weight of wood flour, between approximately 5% and approximately 15% by weight of gilsonite, between approximately 1% and approximately 4% by weight of perlite, between approximately 1% and approximately 3% by weight of xanthan gum, between approximately 1% and approximately 4% by weight of lime, and between approximately 1% and approximately 20% by weight of mineral wool, wherein the weight totals 100%.
